(19) United States
(12) Patent Application Publication
(10) Pub. No.: US 2012/0159622 A1
(43) Pub. Date: Jun. 21, 2012

(54) METHOD AND APPARATUS FOR GENERATING ADAPTIVE SECURITY MODEL

(75) Inventor: Seungmin LEE, Daejeon (KR)

(73) Assignee: Electronics and Telecommunications Research Institute, Daejeon (KR)

(21) Appl. No.: 13/323,263

(22) Filed: Dec. 12, 2011

(30) Foreign Application Priority Data
Dec. 21, 2010 (KR) 10-2010-0131801

(51) Int. Cl. G06F 21/00

(52) U.S. Cl. 726/22

(57) ABSTRACT

A method for generating an adaptive security model includes: generating an initial security model with respect to data input via an Internet during a learning process; and continuously updating the initial security model by applying characteristics of the input data during an online process. Said generating an initial security model includes: matching the input data with a unit having a weight vector with distance closest to the input data using a first unsupervised algorithm; generating a map composed of weight vectors of units; and performing a second unsupervised algorithm using the weight vectors forming the map as input values to partition an attack cluster.

### CROSS-REFERENCE(S) TO RELATED APPLICATION(S)

The present invention claims priority of Korean Patent Application No. 10-2010-0131801, filed on Dec. 21, 2010, which is incorporated herein by reference.

### FIELD OF THE INVENTION

The present invention relates to an Internet security, and more particularly, to a method and an apparatus for generating an adaptive security model, which are capable of detecting an external attack more rapidly and accurately in an Internet environment, by generating a security model, by way of combining an adaptive learning and a dynamic clustering with respect to externally-input data in the internet environment using an unsupervised learning algorithm, and repetitively executing the combined process depending on a specific condition.

### BACKGROUND OF THE INVENTION

In general, a conventional technology for secure Internet includes an intrusion detection technology for detecting cyber attacks, such as hacking, causing abnormally excessive traffic, or the like.

The intrusion detection technology can be largely classified into signature or misuse detection and anomaly detection as follows.

First, the signature or misuse detection is a method of defining characteristic information regarding known types of attacks in advance and performing detection based on the defined characteristic information. The signature or misuse detection is capable of detecting such known types of attacks with high accuracy, but when a new type of attack is detected, characteristic information regarding the detected attack should be updated manually. That is, such a detection method has a limitation on detection of new types of attacks.

The anomaly detection is a method of determining, as an attack, data beyond a range of a profile with respect to predefined normal behaviors, without defining characteristics of specific types of attacks beforehand. For model generation of such a technique, mechanical learning algorithms, such as support vector machine (SVM), self organizing map (SOM) and the like, are used to create a detection model through a learning process. Here, the SVM indicates a representative supervised learning algorithm, and the SOM indicates an unsupervised learning algorithm. As for the supervised learning algorithm, since label information (normal or attack) relating to training data is used during a learning process, it is disadvantageous to make a user perform labeling, but advantageous to exhibit higher accuracy as compared with the unsupervised learning algorithm.

Therefore, the anomaly detection may be an alternative appropriate to address the disadvantage of the signature or misuse detection technique in view of detecting an external attack in an Internet environment.

However, although the anomaly detection is able to detect a new type of attack as compared with the misuse detection technique, it has a high false positive rate that normal data is erroneously determined to be an attack and is unable to satisfactorily recognize detailed characteristics of detected attacks, which results in a limitation on wide use. The representative reason of the low accuracy of the anomaly detection is that an anomaly detection model generated during a learning process cannot apply actual data characteristics as it is.

Especially, with regard to the characteristics of Internet data in recent years, since new types of application programs and users' Internet use behaviors change very rapidly, there may be a need of a security model by which actual data characteristic can be applied in real time. Also, the security model may be considered as practical one only when it can be self-generated without possible intervention of a user during a learning process and an online process.

### SUMMARY OF THE INVENTION

In view of the above, the present invention provides a method and apparatus for generating an adaptive security model, which are capable of detecting an external attack more rapidly and accurately in an Internet environment, by generating a security model, which allows for dynamic application of data characteristics during a learning process as well as an online process and enables an autonomous update without an intervention of a user or the like, by way of combining an adaptive learning and a dynamic clustering with respect to externally-input data in the Internet environment using an unsupervised learning algorithm, and repetitively executing the combined process depending on a specific condition.

In accordance with an aspect of the present invention, there is provided a method for generating an adaptive security model including: generating an initial security model with respect to data input via an Internet during a learning process; and continuously updating the initial security model by applying characteristics of input data during an online process.

In accordance with another aspect of the present invention, there is provided an apparatus for generating an adaptive security model including: an adaptive learning unit for matching input data with a map of units forming a low-dimensional space; and a dynamic clustering unit for partitioning a cluster, wherein the adaptive learning unit and the dynamic clustering unit are used in a learning and an on-line processes.

### BRIEF DESCRIPTION OF THE DRAWINGS

The objects and features of the present invention will become apparent from the following description of embodiments, given in conjunction with the accompanying drawings, in which:

FIG. 1 is a view illustrating a configuration of an apparatus for generating an adaptive security model in accordance with an embodiment of the present invention;

FIG. 2 is a flowchart illustrating sequential operations of a learning process and an online process in the apparatus for generating an adaptive security model in accordance with the embodiment of the present invention; and

FIGS. 3A and 3B are conceptual views illustrating the operation of three phases of an online process in accordance with an embodiment of the present invention.

### DETAILED DESCRIPTION OF THE EMBODIMENT

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks, of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, embodiments of the present invention will be described in detail with the accompanying drawings which form a part hereof.

The adaptive security model generation method in accordance with the embodiment of the present invention includes a learning process in which an initial security model with respect to data input via an Internet is generated and an online process in which the initial security model is continuously updated by applying characteristics of the input data. In these processes, algorithms of SOM and K-means are applied. To help understanding, a description will be first given the algorithms of SOM and K-means of an anomaly detection technique.

The following Table 1 shows an operational process of the SOM.

TABLE 1
Step 1. Construct a weight vector w and initialize it
Step 2. Calculate the distance between an i-th input vector xi
and each unit weight wⱼ, and therefore choose the wining unit or
BMU, d = min{|xᵢ − wⱼ|}, where |•| is the Euclidean distance and wⱼ
is the weight vector of unit j
Step 3. Adjust the weights for the winners and all its neighbors
as

wᵢⱼ(t + 1) = wᵢⱼ(t) + η(t)h(j, t){xᵢ − wᵢⱼ(t)},
where η(t) is the learning rate at epoch t; and h(j, t) is the

neighborhood kernel function centered on the winning unit
Step 4. Repeat steps 2 to 4 until the convergence criterion is
satisfied

As shown in Table 1, a high dimensional data space is mapped to a map of units forming a low dimensional, e.g., two-dimensional space. Each unit has a weight vector with the same dimension as input data, and the input data is matched with a unit having a weight vector with distance closest thereto, namely, a best matching unit (BMU).

That is, upon completion of learning by the SOM, every input data is matched with one unit on a low dimensional map formed with units, and especially, data, such as attack data, which has a different characteristic from normal data, tends to be clustered in one portion of the map.

Hereinafter, the operation of the K-means algorithm will be described. The following Table 2 shows an operational process of the K-means algorithm as one of unsupervised learning algorithms, and K clusters different from one another are eventually created.

TABLE 2

initialize μ₁,...,μₖ by random selection
while(no changes in clusters Sⱼ happen)
for i=1,...,n

calculate |xᵢ−μⱼ|² for all centers
assign data point i to the closest center

end for

recompute each μⱼ as the centroid of the data points

end while

Referring to Table 2, when an n-number of input data are present, such n input data are classified into K different clusters Sₖ, which minimize SSₖ represented in the following Eq. 1:

$${SS}_{k} = {Q}_{j = 1}^{K} {Q}_{{nHS}_{j}} {\vert {x}_{n} - {μ}_{j} \vert}^{2} , \qquad Eq . 1$$

where xₙ denotes n^{th} data, and μⱼ denotes a centroid of data belonging to the cluster Sₖ.

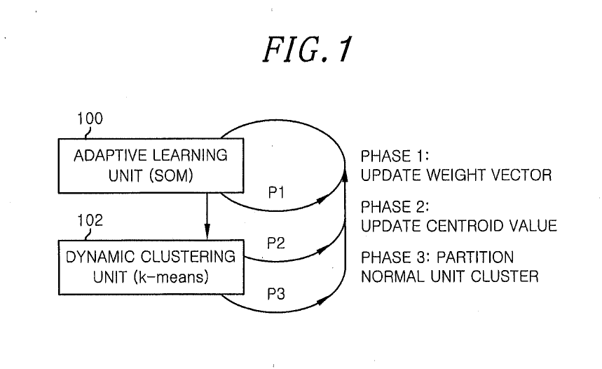

FIG. 1 is a view illustrating a configuration of an apparatus for generating an adaptive security model in accordance with an embodiment of the present invention.

Referring to FIG. 1, an adaptive learning unit 100 is a module for performing an SOM algorithm, which updates weight vectors of an SOM map with respect to input data.

That is, the adaptive learning unit 100 matches externally-input data with a map of units constituting a low-dimensional space using the SOM algorithm. Here, each unit has a weight vector with the same dimension as the input data, and the input data is matched with a unit having a weight vector with distance closest thereto, namely, the BMU.

After matching each input data with a unit on the low-dimensional map of units, the adaptive learning unit 100 then updates a weight vector of each unit. Here, a phenomenon that data, such as attack data, which has a different characteristic from normal data, is clustered into a portion of the map arises.

A dynamic clustering unit 102 updates a centroid of an attack cluster in the clustered units on the map, and partitions a normal unit cluster, thereby generating a new attack cluster.

The conception of the present invention will be described once again with reference to FIG. 1. That is, a model update in the online process is performed by three phases, and basically two algorithms, namely, SOM and K-means algorithms are consecutively executed.

A weight vector of the SOM map is updated with respect to input data at a first phase P1, a centroid of an attack cluster is updated in clustered units on the map at a second phase P2, and a new attack cluster is generated by partitioning a normal unit cluster at a third phase P3.

Through this three-phase online process, a security model update may be automatically carried out without a user's intervention. In addition, a characteristic of input data may be rapidly applied to allow for an autonomous learning, which results in more accurate detection and identification of an external intrusion, as compared with the conventional fixed security model.

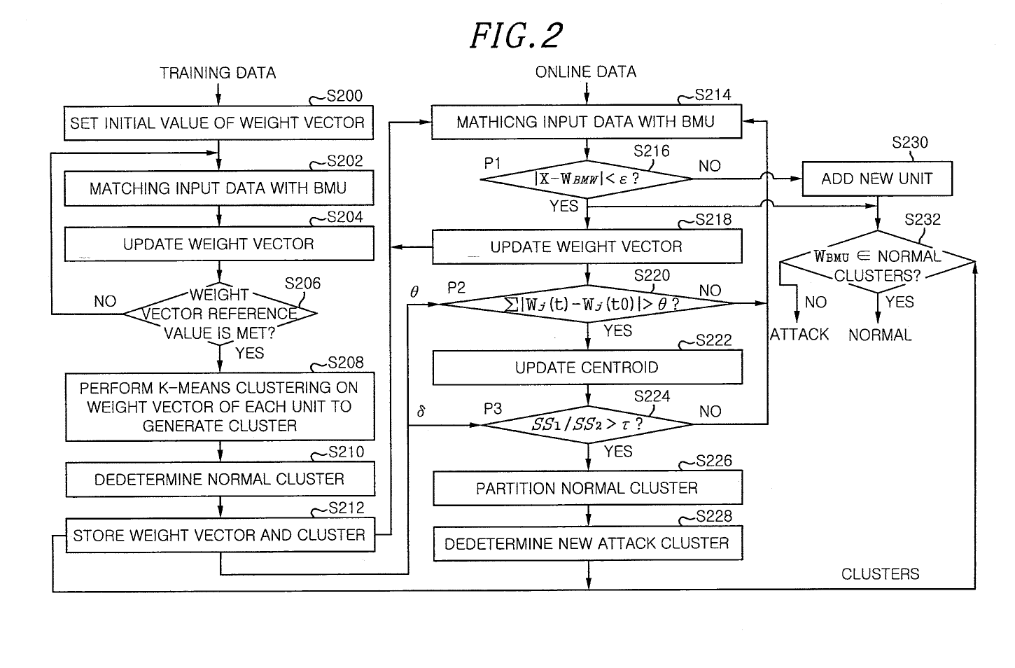

FIG. 2 is a flowchart showing sequential operations of a learning process and the online process in the apparatus for generating the security model in accordance with the present invention. The present invention consecutively uses both SOM and K-means for the learning process and the online process.

First, sequential operations of the learning process will be described. That is, the adaptive learning unit 100 sets an initial value of a weight vector of each unit in step S200, matches the input data with a unit having a weight vector with a distance closest thereto, i.e., the BMU. in step S202, and updates the weight vectors in step S204.

Next, the adaptive learning unit 100 checks whether or not the weight vectors meet a preset convergence condition of a certain reference value in step S206, and repetitively carries out the learning process of the SOM (steps S200 to S206) until the weight vectors satisfy the convergence condition of the certain reference value.

A map obtained through these sequential operations is formed with weight vectors of units, and it can be seen that weight vectors matching with attack data congregate in one side on the map. However, although such results on the map can be visually noticed, a separate calculation process is needed to obviously discriminate the boundary between a normal portion and the other portions which are not normal.

To automatically address the calculation process, the K-means is performed by using, as input data, units of the map generated after performing the learning of the SOM by the dynamic clustering unit 102.

That is, K-means clustering is carried out for the weight vectors of the respective units to generate clusters in step S208, a normal cluster is determined in step S210, and a weight vector of the normal cluster and a threshold value θ and a distance δ of the cluster are stored in step S212.

In this manner, the consecutive application of the SOM and the K-means may facilitate creation of a security model, by which an attack cluster and a normal cluster can be distinguished by using a large amount of training data during the learning process.

Next, regarding sequential operations of the online process, the adaptive learning unit 100 and the dynamic clustering unit 102 carries out a three-phase online learning based on a specific condition, i.e., three types of threshold values for consecutively applying the characteristics of input online data.

First, by the adaptive learning unit 100, input data is matched with a BMU at a first phase in step S214, and it is checked whether a distance between the input data x and a weight vector W_{BMU} of the BMU matching with the input data x is more than a threshold value ε in step S216.

If it is checked that the distance between the input data x and the corresponding weight vector W_{BMU} is more than the threshold value ε, a new unit is added in step S230. Thereafter, it is checked whether the weight vector belongs to one of the normal clusters, to determine whether the input data is normal data or attack data in step S232.

On the contrary, if it is checked that the distance between the input data x and the corresponding weight vector W_{BMU} is less than the threshold value ε, the weight vector is updated in step S218. Also, it is checked whether the weight vector belongs to one of the normal clusters, to determine whether the input data is normal data or attack data by proceeding to step S232 from S216.

Subsequently, by the dynamic clustering unit 102, it is checked at a second phase whether an accumulated change value of the weight vectors of units belonging to an attack cluster is more than a threshold value θ, i.e., meets the following Eq. 2, in step S220. If Eq. 2 is met, an average value of the units belonging to the attack cluster is calculated to update a centroid of the cluster in step S222.

$${Q}_{j = 1}^{m} \vert {w}_{j} ( t ) - {w}_{j} ( {t}_{0} ) \vert > θ , \qquad Eq . 2$$

where t and t₀ denote a current time and an initial time, respectively, and m denotes the number of units belonging to the attack cluster.

Finally, at a third phase, the change in the normal cluster is observed, and simultaneously whether the degree of change SS₁/SS₂ exceeds a threshold value t is checked in step S224, by the dynamic clustering unit 102. Herein, SS₁ and SS₂ may be expressed by the following Eq. 3:

$${SS}_{1} = {Q}_{{x}_{n} HB} {\vert {x}_{n} - {μ}_{B} \vert}^{2} \\ {SS}_{2} = {Q}_{{x}_{n} HB 1} {\vert {x}_{n} - {μ}_{B 1} \vert}^{2} + {Q}_{{x}_{n} HB 2} {\vert {x}_{n} - {μ}_{B 2} \vert}^{2} \qquad Eq . 3$$

If it is checked that the degree of change SS₁/SS₂ exceeds the threshold value τ, an attack cluster is partitioned from the normal cluster in step S226, and the partitioned attack cluster is determined as a new attack cluster in step S228.

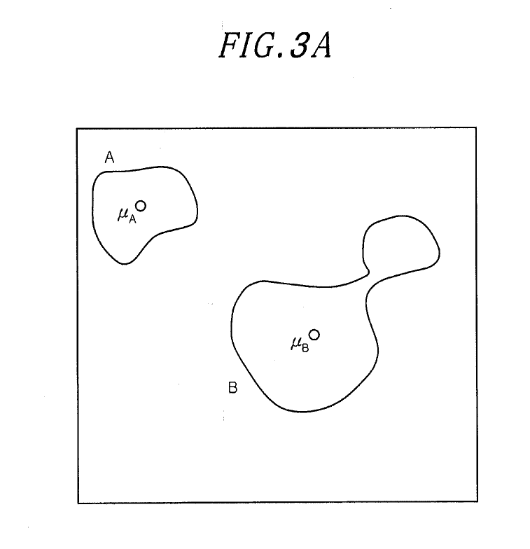

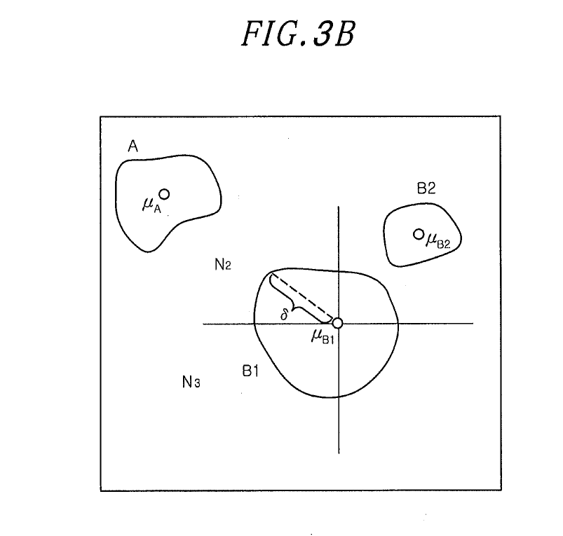

FIGS. 3A and 3B are conceptual views illustrating the operation of the three phases of the online process in accordance with an embodiment of the present invention.

Referring to FIG. 3A, a part A on the left top indicates an attack cluster, and a part B indicates a normal cluster. FIG. 3B shows that a new attack cluster B2 is partitioned from a normal cluster B1.

Here, it is assumed that xₙ is a weight vector of an n-th unit, and μᵢ is a centroid of a cluster i. It is also assumed that N is the number of data, which is located away from μ_{B} by more than a distance δ and observed most recently. In this case, when the number of data located in a different direction from the existing attack cluster exceeds a ratio φ of N, the K-means clustering of K=2 is performed when the following Eq. 4 is met.

SS₁/SS₂<τ Eq. 4

As described above, in generating the adaptive security model in accordance with the present invention, an adaptive learning and a dynamic clustering are combined with respect to externally-input data in an Internet environment using an unsupervised learning algorithm, and the combined process is repetitively performed based on a specific condition, thereby generating a security model, which allows for dynamic application of data characteristics during an online process as well as a learning process and enables and autonomous update without a user's intervention. The generated security model can be used to detect an external attack more rapidly and accurately in the Internet environment, resulting in ensuring more secure Internet environment.

In addition, in accordance with the present invention, unlike the conventional method, in order to determine whether data is an attack or not by recognizing characteristics of such data using an Internet, characteristics of online data may be applied in real time to update a security model to detect a new type of attack more rapidly and accurately, and also determination as to updating of the security model or whether data is an attack or not can be performed automatically without a user's intervention, thereby improving functionality and performance of an intrusion detection system.

While the invention has been shown and described with respect to the particular embodiments, it will be understood by those skilled in the art that various changes and modification may be made without departing from the scope of the invention as defined in the following claims.

What is claimed is:

1. A method for generating an adaptive security model, the method comprising:
generating an initial security model with respect to data input via an Internet during a learning process; and
continuously updating the initial security model by applying characteristics of input data during an online process.

2. The method of claim 1, wherein said generating the initial security model includes:
matching input data with units having weight vectors with distances closest to the input data by using a first unsupervised algorithm;
performing a second unsupervised algorithm using the weight vectors forming a map as input values to partition an attack cluster.

3. The method of claim 1, wherein said updating the initial security model includes:
checking the distances between the input data and the weight vectors of the units matching with the input data;
adding a new unit when each of the distances is more than a preset threshold value, and then determining whether input data related to the distance is normal data or attack data; and
updating weight vector related to the distance when the distance is less than a preset threshold value.

4. The method of claim 3, further comprising, after said updating the weight vector:
checking an accumulated change value of weight vectors of units belonging to an attack cluster of the input data; and
updating a centroid of the attack cluster when the accumulated change value of the weight vectors is more than a preset threshold value.

5. The method of claim 4, wherein the centroid is measured by calculating an average value of the units belonging to the attack cluster.

6. The method of claim 4, further comprising, after said updating a centroid:
checking a degree of change in a normal cluster of the input data; and
partitioning a new attack cluster from a normal cluster when the degree of change of the normal cluster exceeds a preset threshold value.

7. The method of claim 2, wherein the first unsupervised algorithm is a self organizing map (SOM) algorithm.

8. The method of claim 2, wherein the second unsupervised algorithm is a K-means algorithm.

9. An apparatus for generating an adaptive security model, the apparatus comprising:
an adaptive learning unit for matching input data with a map of units forming a low-dimensional space; and
a dynamic clustering unit for partitioning a cluster, wherein the adaptive learning unit and the dynamic clustering unit are used in a learning and an on-line processes.

10. The apparatus of claim 9, wherein the adaptive learning unit matches the input data with units having weight vectors with distances closest to the input data by using a first unsupervised algorithm.

11. The apparatus of claim 10, wherein the adaptive learning unit adds a new unit when each of the distances is more than a preset threshold value, and then determines whether input data related to the distance is normal data or attack data.

12. The apparatus of claim 10, wherein when each of the distances is less than the preset threshold value, the adaptive learning unit updates a weight vector related to the distance.

13. The apparatus of claim 10, wherein the dynamic clustering unit performs a second unsupervised algorithm using weight vectors of the units forming the map as input values to partition an attack cluster.

14. The apparatus of claim 12, wherein, after updating the weight vector, the dynamic clustering unit updates a centroid of the attack cluster when an accumulated change value of the weight vectors of the units belonging to an attack cluster of the input data is more than a preset threshold value.

15. The apparatus of claim 14, wherein the centroid is measured by calculating an average value of the units belonging to the attack cluster.

16. The apparatus of claim 14, wherein, after updating the centroid, the dynamic clustering unit partitions a new attack cluster from a normal cluster when a degree of change in a normal cluster of the input data exceeds a preset threshold value.

17. The apparatus of claim 10, wherein the first unsupervised algorithm is a self organizing map (SOM) algorithm.

18. The apparatus of claim 13, wherein the second unsupervised algorithm is a K-means algorithm.
